(19) United States
(12) Patent Application Publication
(10) Pub. No.: US 2022/0323192 A1
(43) Pub. Date: Oct. 13, 2022

(54) TOOTH ARRANGEMENT DECAL

(71) Applicant: Michael A. Creech, Angier, NC (US)

(72) Inventor: Michael A. Creech, Angier, NC (US)

(21) Appl. No.: 17/229,639

(22) Filed: Apr. 13, 2021

(51) Int. Cl. A61C 19/10; A61C 13/34; A61C 13/00

(52) U.S. Cl. CPC A61C 19/10; A61C 13/34; A61C 13/0027

(57) ABSTRACT

A tooth arrangement decal constructed and arranged to facilitate the rapid communication of the placement of prostheses with respect to prosthetic teeth on a wax rim and a method of using the same is provided. The tooth arrangement decal may instruct the arrangement of teeth, and in particular, central incisors, lateral incisors, and canines. The tooth arrangement decal may be constructed and arranged to eliminate the need for tedious measurements and inscription of markings on a wax ring to indicate the appropriate location for prostheses during denture set-up.

### TECHNICAL FIELD

The field to which the disclosure generally relates includes dental prostheses and methods of arranging dental prostheses.

### BACKGROUND

A patient needing dentures and or partial dentures may have preliminary impressions taken of patient's upper and lower arches. From the impressions, a stone model replica of patient's oral anatomy may be created. A bite rim may be prepared that may include a base plate formed to fit a patient's edentulous ridge. The base plate may include a rigid material such as acrylic or similar polymer or plastic. A wax rim may be disposed on an upper surface of the base plate. The wax rim may be in locations in which a patient's natural teeth are missing. The placement, height, and thickness of wax may be consistent with anatomical averages of oral anatomy. Wax is used so that if modifications are needed, dentist can easily reshape, remove, or add additional wax to achieve desired results.

The bite rim provides accurate information to a dental technician such that an ideal denture can be fabricated. The bite rim is used to provide information to a dental technician by way of measurements and markings made on the bite rim to indicate denture construction and arrangement including, but not limited to, how the upper arch relates to the lower arch, the proper distance between arches, proper facial contouring for ideal lip support, marking of the midline on wax to indicate placement of denture teeth including the midline i.e. the center of the front two teeth, the low lip line indicating length of teeth, high lip line indicating height of teeth, marking the canine to canine eminence indicating the width of the front six anterior teeth, and horizontal marking indicating the levelness of the front six anterior teeth. The more information given to dental technician, the more precise and accurate the denture set-up will be for optimal form and function. In this way, a dentist must measure and mark several indicators on the wax rim to provide a precise and accurate denture set-up for optimal form and function.

A wax rim having markings and indicators may be provided to a dental technician for set-up of denture teeth in the wax rim. Denture teeth may be set in the wax rim according to the previously indicated measurements. This process may include selecting sets of or individual denture teeth of appropriate size and shape according to the indicated measurements, the comfort of the patient while wearing the denture, and overall aesthetic appearance. Denture teeth set in the wax rim also provide an opportunity for both dentist and patient to preview a completed denture. Modifications may also be made to the wax rim as needed prior to finalizing denture.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A tooth arrangement decal may be constructed and arranged to facilitate the rapid communication of the placement of prostheses with respect to prosthetic teeth on a wax rim. The tooth arrangement decal may instruct the arrangement of teeth, and in particular, central incisors, lateral incisors, and canines. The tooth arrangement decal may be constructed and arranged to eliminate the need for tedious measurements and inscription of markings on a wax rim to indicate the appropriate location for prostheses.

A method of utilizing a tooth arrangement decal to expedite the preparation of denture set-up may include forming preliminary impressions taken of a patient's upper and lower arches; forming a stone model replica of patient's oral anatomy; forming a bite rim may include forming a base plate formed to fit a patient's edentulous ridge and disposing a wax rim on the base plate. The method may further include providing at least one tooth arrangement decal; and attaching the at least one tooth arrangement decal to the wax rim.

A method of utilizing a tooth arrangement decal in the preparation of denture set-up may include providing at least one tooth arrangement decal that may include a first substrate may include a first surface opposite a second surface; a removable decorative layer may include a third surface opposite a fourth surface disposed on a first surface of the first substrate, such that the first surface and the third surface abut; a layer of removable adhesive disposed on the third surface; and a decorative image disposed on a fourth surface of the decorative layer; removing the removable decorative layer and removable adhesive from the first substrate; and attaching the removable decorative layer and removable adhesive to a wax rim.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

The features and advantages of the present disclosure will be more fully described in, or rendered obvious by the following detailed description of the preferred embodiments, which are to be considered together with the accompanying drawings wherein like numbers refer to like parts and further, wherein:

FIG. 1 is a use case diagram illustrative of a method of utilizing a tooth arrangement decal to expedite the preparation of denture set-up;

FIG. 2 is a cross-sectional view of an illustrative variation of a tooth arrangement decal; and

FIG. 3 is a front-facing view of an illustrative variation of a tooth arrangement decal.

### DETAILED DESCRIPTION

Reference will now be made in detail to the present preferred embodiment(s), and examples of which is/are illustrated in the accompanying drawings. Whenever possible, the same reference numerals will be used throughout the drawings to refer to the same or like parts. Any specific details of the embodiments are used for demonstration purposes only, and no unnecessary limitations or inferences are to be understood therefrom.

The following description of the variations is merely illustrative in nature and is in no way intended to limit the scope of the invention, its application, or uses. The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and still are within the scope of the invention.

A tooth arrangement decal may be constructed and arranged to facilitate the rapid communication of the placement of prostheses with respect to prosthetic teeth on a wax rim without the need for conventional measurements and markings such as, but not limited to, the mid-line, low lip line, high lip line, width of teeth from canine to canine, horizontal levelness. In particular, tooth arrangement decal may be constructed and arranged to facilitate the rapid communication of the placement of prostheses with respect to teeth 6-11, otherwise referred to as anterior teeth including canines, lateral incisors, and central incisors. The tooth arrangement decal may be constructed and arranged to facilitate the rapid communication of the placement of prostheses with respect to teeth other than 6-11.

Conventionally, the mid-line may be marked with a clinical instrument such as a cutting or scoring tool in the middle of the wax rim to be consistent with overall facial anatomy. The marking of wax is scored with the instrument such that a visible line in wax shows dental technician desired midline between teeth 8 & 9. The low lip may be marked with clinical instrument at the bottom of or slightly below the patient's upper lip to indicate desired position of incisal edge of anterior centrals 8 & 9. The high lip line may be scribed below the lip when the lip is raised to its maximum height to indicate the desired height of tooth to be utilized. The width of anterior teeth 6-11, from canine to canine may be indicated on the wax rim by scribing marks on the wax rim indicating the desired distal edge of each canine. After both sides are marked, this will show the total distance needed to span the space of anterior teeth 6-11. A horizontal line may be scribed in the wax indicating a horizontal line to ensure level positioning of teeth. A dental professional may use the aforementioned measurements and markings along with patients overall facial anatomy, gender, age, skin tone, etc., to select a mold and shade/color of denture tooth. Additionally, excess wax may be added or removed from the facial aspect of the wax rim to ensure that facial and side profile of the wearer's lips are supported in a natural manner and are aesthetically pleasing to the patient.

The tooth arrangement decal may be constructed and arranged to facilitate the rapid communication of the placement of prostheses with respect to teeth numbers 6-11 by providing adhesive-backed images of anterior molds for denture teeth which may be affixed to a wax rim without the need for performing the laborious and time-consuming conventional method of measuring and marking of a wax rim. The tooth arrangement decal may include a first film substrate, such as vinyl, plastic, paper, release liner, or other material sufficient for temporarily applying a sticker or decal thereto and from which a decorative layer may be easily removed. A decorative layer may be disposed on a first surface of the first film substrate. The decorative layer may be a decal, sticker, vinyl, film, or any other suitable layer which a decorative image may be printed or disposed thereon. The decorative layer may include a decorative image that may display a front facing view of teeth 6 through 11. Alternatively, the decorative image may display a front facing view of any tooth or any combination or sub-combination of teeth. The decorative image may be disposed on a first surface of the decorative layer opposite a second surface of the decorative layer which may have an adhesive disposed thereon. The adhesive may be a pressure sensitive heat adhesive, temperature sensitive adhesive, or any other suitable adhesive for attaching the decorative layer to a wax rim. Alternatively, no such adhesive may be necessary for attaching the decorative layer to the wax rim. For example, the decorative layer may be attached to the wax rim by gently heating the wax rim until liquid wax has pooled and the desired location for placement of the decorative layer. The warmed wax rim may act as an adhesive for the decorative layer. Alternatively, water may be used as an adhesive for affixing the decorative layer to the wax rim via surface tension. The means for attaching the decorative layer to the wax rim not described herein are still considered part of the scope of the disclosure.

The decorative image may display teeth of varying sizes, shapes, colors, and arrangements. The decorative image may be constructed and arranged to convey the proper appearance of teeth 6 through 11 and the location of teeth 6 through 11 with respect to the midline, the low lip line, the high lip line, the width of teeth from canine to canine, the horizontal levelness of the teeth, and facial aspect. When applied to the wax rim, the decorative layer having a decorative image thereon may meaningfully convey the arrangement of teeth for the purposes of denture set-up. The decorative image may also be constructed and arranged to provide a preview of how the finalized denture will appear in a patient's mouth. In this way, the tooth arrangement decal may be constructed and arranged to greatly reduce the time and effort involved in conveying proper positioning of teeth 6 through 11 during denture set-up by removing the need to measure and mark on the wax rim the midline, low lip line, high lip line, width of teeth from canine to canine, the horizontal level of teeth 6 through 11, and facial aspect.

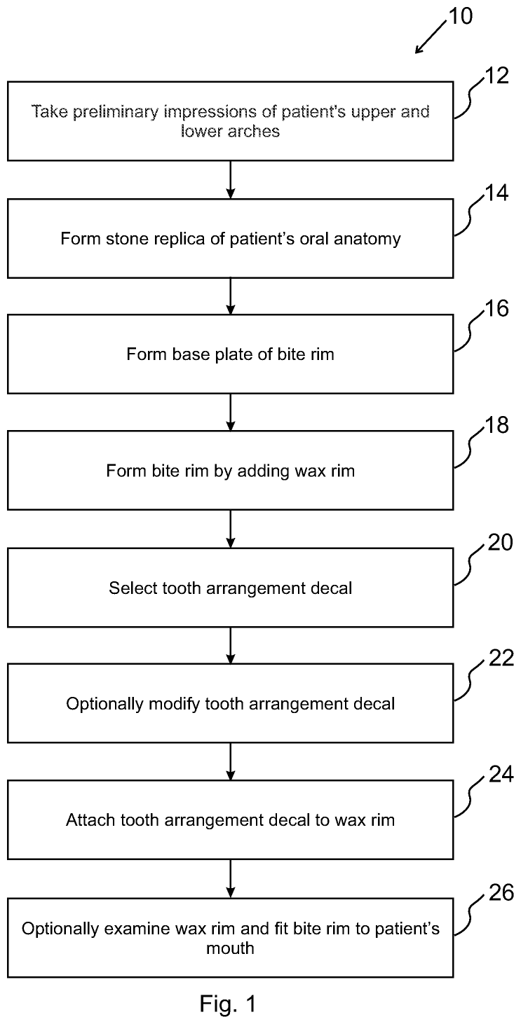

Referring to FIG. 1, the tooth arrangement decal and method of using the same 10 may assist a patient needing dentures and or partial dentures by reducing time and effort required in preparing the denture set-up. A nonlimiting example of using the tooth arrangement decal may include the following steps. According to step 12, a patient may have preliminary impressions taken of patient's upper and lower arches. Step 14, from the impressions, a stone model replica of patient's oral anatomy may be created. Step 16, a bite rim may be prepared that may include a base plate formed to fit a patient's edentulous ridge. Step 18, a wax rim may be disposed on an upper surface of the base plate to complete the bite rim. Step 20, a tooth arrangement decal may be selected most appropriate for the patient including considerations with respect to midline, low lip line, high lip line, the width of teeth from canine to canine, the horizontal levelness of the teeth, and facial aspect. Step 22, the tooth arrangement decal maybe modified as required including, but not limited to, cutting the decal to include the portion of the decal only necessary to convey the location and arrangement of the teeth of the denture or partial denture. Step 24, the tooth arrangement decal may be fixed to the wax rim in the appropriate location according to the considerations described herein. Step 26 may include fully seating the bite rim in the patient's mouth to confirm desired arrangement and positioning for final denture set-up. In this way, the tooth arrangement decal may greatly reduce the time and effort involved in conveying proper positioning of teeth 6 through 11 during denture set-up by removing the need to measure and mark on the wax rim the midline, low lip line, high lip line, the width of teeth from canine to canine, the horizontal level of teeth 6 through 11, and facial aspect.

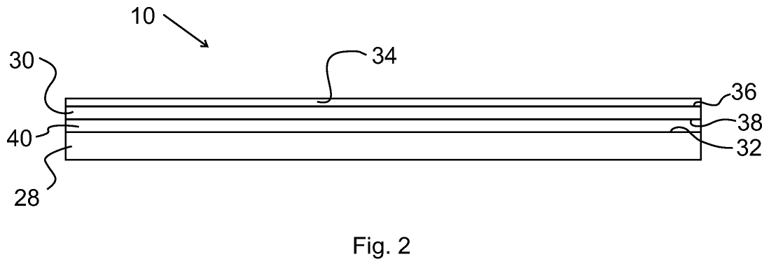

Referring to FIG. 2, the tooth arrangement decal 10 may include a first film substrate 28. A decorative layer 30 may be disposed on a first surface 32 of the first film substrate 28. The decorative layer 30 may include a decorative image 34 that may display a front facing view of teeth 6 through 11 as described previously herein. Alternatively, the decorative image 34 may display a front facing view of any tooth or any combination or sub-combination of teeth. The decorative image 34 may be disposed on a second surface 36 of the decorative layer opposite a third surface 38 of the decorative layer which may have an adhesive 40 disposed thereon. Alternatively, no such adhesive may be present or necessary for attaching the decorative layer to a wax rim.

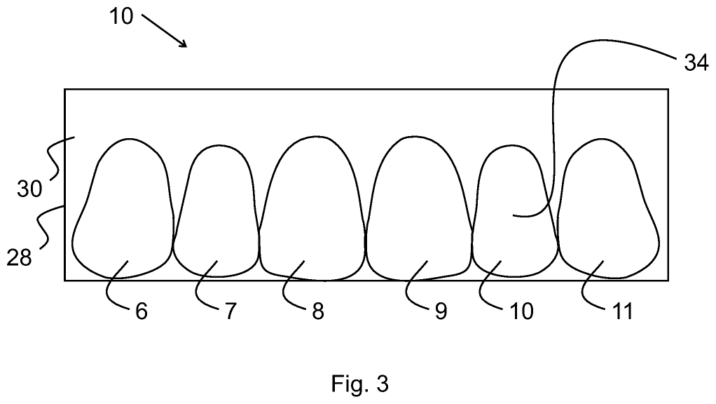

Referring to FIG. 3, the tooth arrangement decal 10 may include a first film substrate 28. A decorative layer 30 may be disposed on the first film substrate 28. The decorative layer 30 may include a decorative image 34 that may display a front facing view of the central incisors 8 and 9, lateral incisors 7 and 10, and canines 6 and 11. Alternatively, the decorative image 34 may display a front facing view of any tooth or any combination or sub-combination of teeth. The tooth arrangement decal 10 may be applied to a wax rim and may convey the arrangement of teeth for the purposes of denture set-up.

According to variation 1, a tooth arrangement decal may include a first substrate that may include a first surface opposite a second surface; a removable decorative layer that may include a third surface opposite a fourth surface, the removable decorative layer being disposed on a first surface of the first substrate, such that the first surface and the third surface abut; and a decorative image disposed on a fourth surface of the decorative layer wherein the decorative image may include a front facing view of at least one anterior tooth.

Variation 2 may include the tooth arrangement decal as set forth in variation 1, wherein the decorative image may include a front facing view of at least one of a canine, lateral incisor, or central incisor.

Variation 3 may include the tooth arrangement decal as set forth in variations 1 through 2, wherein the decorative image may include a front facing view of anterior teeth that may include canines, lateral incisors, and central incisors.

Variation 4 may include the tooth arrangement decal as set forth in variations 1 through 3, and further may include a layer of adhesive disposed between the abutting first surface and third surface.

Variation 5 may include the tooth arrangement decal as set forth in variations 1 through 4, wherein the adhesive is a removable adhesive.

Variation 6 may include a method of utilizing a tooth arrangement decal to expedite the preparation of denture set-up, the method may include forming preliminary impressions of a patient's upper and lower arches; forming a stone model replica of patient's oral anatomy; forming a bite rim may include forming a base plate formed to fit a patient's edentulous ridge and disposing a wax rim on the base plate. The method may further include providing at least one tooth arrangement decal and attaching the at least one tooth arrangement decal to the wax rim.

Variation 7 may include the method of utilizing a tooth arrangement decal to expedite the preparation of denture set-up as set forth in variation 6 wherein the tooth arrange decal may include a first substrate may include a first surface opposite a second surface; a removable decorative layer that may include a third surface opposite a fourth surface, the removable decorative layer being disposed on a first surface of the first substrate such that the first surface and the third surface abut; and a decorative image disposed on a fourth surface of the decorative layer wherein the decorative image may include a front facing view of at least one anterior tooth.

Variation 8 may include the method of utilizing a tooth arrangement decal to expedite the preparation of denture set-up as set forth in any of variations 6 through 7 wherein the decorative image may include a front facing view of at least one of a canine, lateral incisor, or central incisor.

Variation 9 may include the method of utilizing a tooth arrangement decal to expedite the preparation of denture set-up as set forth in any of variations 6 through 8 wherein the decorative image may include a front facing view of anterior teeth that may include canines, lateral incisors, and central incisors.

Variation 10 may include the method of utilizing a tooth arrangement decal to expedite the preparation of denture set-up as set forth in any of variations 6 through 9 and further may include a layer of adhesive disposed between the abutting first surface and third surface.

Variation 11 may include the method of utilizing a tooth arrangement decal to expedite the preparation of denture set-up as set forth in any of variations 6 through 10, wherein the adhesive is a removable adhesive.

Variation 12 may include the method of utilizing a tooth arrangement decal to expedite the preparation of denture set-up as set forth in any of variations 6 through 11 wherein providing the at least one tooth arrangement decal may include providing a plurality of varying tooth arrangement decals.

Variation 13 may include the method of utilizing a tooth arrangement decal to expedite the preparation of denture set-up as set forth in any of variations 6 through 12 wherein the plurality of varying tooth arrangement decals each may include decorative images of teeth of varying sizes, shapes, colors, and arrangements.

Variation 14 may include the method of utilizing a tooth arrangement decal to expedite the preparation of denture set-up as set forth in any of variations 6 through 13 wherein, prior to attaching the at least one tooth arrangement decal to the wax rim, the least one tooth arrangement decal may be selected for the patient including considerations with respect to midline, low lip line, high lip line, the width of teeth from canine to canine, the horizontal levelness of the teeth, and facial aspect.

Variation 15 may include the method of utilizing a tooth arrangement decal to expedite the preparation of denture set-up as set forth in any of variations 6 through 14 and further may include modifying the decal to include the portion of the decal necessary to convey the location and arrangement of the teeth of the denture set-up.

Variation 16 may include the method of utilizing a tooth arrangement decal to expedite the preparation of denture set-up as set forth in any of variations 6 through 15 and further may include fully seating the bite rim in a patient's mouth to confirm desired arrangement and positioning for final denture set-up.

According to variation 17, a method of utilizing a tooth arrangement decal in the preparation of denture set-up may include providing at least one tooth arrangement decal that may include a first substrate that may include a first surface opposite a second surface; a removable decorative layer may include a third surface opposite a fourth surface, the removable decorative layer being disposed on a first surface of the first substrate, such that the first surface and the third surface abut; a layer of removable adhesive disposed on the third surface; and a decorative image disposed on a fourth surface of the decorative layer; removing the removable decorative layer and removable adhesive from the first substrate; and attaching the removable decorative layer and removable adhesive to a wax rim.

Variation 18 may include utilizing a tooth arrangement decal in the preparation of denture set-up as set forth in variation 17, wherein the decorative image may include a front facing view of at least one of a canine, a lateral incisor, or a central incisor.

Variation 19 may include utilizing a tooth arrangement decal in the preparation of denture set-up as set forth in any of variations 17 through 18, wherein providing at least one tooth arrangement decal may include selecting the least one tooth arrangement decal for the patient including considerations with respect to midline, low lip line, high lip line, the width of teeth from canine to canine, the horizontal levelness of the teeth, and facial aspect.

Variation 20 may include utilizing a tooth arrangement decal in the preparation of denture set-up as set forth in any of variations 17 through 19, wherein prior to removing the removable decorative layer and removable adhesive from the first substrate, modifying the decal to include a portion of the decal necessary to convey the location and arrangement of the teeth of the denture set-up.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the profession, or to enable others of ordinary skill in the art to understand the embodiments disclosed herein. Thus, the appended claims should be construed broadly, to include other variants and embodiments, which may be made by those skilled in the art.

I claim:

1. A tooth arrangement decal, comprising:
a first substrate comprising a first surface opposite a second surface;
a removable decorative layer comprising a third surface opposite a fourth surface , the removable decorative layer being disposed on the first surface of the first substrate, such that the first surface and the third surface abut; and
a decorative image disposed on the fourth surface of the decorative layer wherein the decorative image displays at least one anterior tooth.

2. The tooth arrangement decal as set forth in claim 1 wherein the decorative image comprises a front facing display of at least one of a canine, lateral incisor, or central incisor.

3. The tooth arrangement decal as set forth in claim 1 wherein the decorative image comprises a front facing display of anterior teeth comprising canines, lateral incisors, and central incisors.

4. The tooth arrangement decal as set forth in claim 1, further comprising a layer of adhesive disposed between the abutting first surface and third surface.

5. The tooth arrangement decal as set forth in claim 4 wherein the adhesive is a removable adhesive.

6. A method of utilizing a tooth arrangement decal to expedite the preparation of denture set-up, comprising:
forming preliminary impressions of a patient's upper and lower arches;
forming a stone model replica of patient's oral anatomy;
forming a bite rim comprising:
forming a base plate formed to fit a patient's edentulous ridge;
disposing a wax rim on the base plate;
providing at least one tooth arrangement decal; and
attaching the at least one tooth arrangement decal to the wax rim.

7. The method of utilizing a tooth arrangement decal to expedite the preparation of denture set-up as set forth in claim 6, wherein the tooth arrange decal comprises:
a first substrate comprising a first surface opposite a second surface,
a removable decorative layer comprising a third surface opposite a fourth surface, the removable decorative layer being disposed on the first surface of the first substrate, such that the first surface and the third surface abut; and
a decorative image disposed on the fourth surface of the decorative layer wherein the decorative image comprises a front facing view of at least one anterior tooth.

8. The method of utilizing a tooth arrangement decal to expedite the preparation of denture set-up as set forth in claim 7, wherein the decorative image comprises a front facing display of at least one of a canine, lateral incisor, or central incisor.

9. The method of utilizing a tooth arrangement decal to expedite the preparation of denture set-up as set forth in claim 7, wherein the decorative image comprises a front facing display of anterior teeth comprising canines, lateral incisors, and central incisors.

10. The method of utilizing a tooth arrangement decal to expedite the preparation of denture set-up, as set forth in claim 7, further comprising a layer of adhesive disposed between the abutting first surface and third surface.

11. The method of utilizing a tooth arrangement decal to expedite the preparation of denture set-up as set forth in claim 10, wherein the adhesive is a removable adhesive.

12. The method of utilizing a tooth arrangement decal to expedite the preparation of denture set-up as set forth in claim 7, wherein providing the at least one tooth arrangement decal comprises providing a plurality of varying tooth arrangement decals.

13. The method of utilizing a tooth arrangement decal to expedite the preparation of denture set-up as set forth in claim 12, wherein the plurality of varying tooth arrangement decals each comprise decorative images of teeth of varying sizes, shapes, colors, and arrangements.

14. The method of utilizing a tooth arrangement decal to expedite the preparation of denture set-up as set forth in claim 7, wherein, prior to attaching the at least one tooth arrangement decal to the wax rim, the least one tooth arrangement decal is selected for the patient including considerations with respect to midline, low lip line, high lip line, the width of teeth from canine to canine, the horizontal levelness of the teeth, and facial aspect.

15. The method of utilizing a tooth arrangement decal to expedite the preparation of denture set-up as set forth in claim 7, further comprising modifying the decal to include only the portion of the decal necessary to convey the location and arrangement of the teeth of the denture set-up.

16. The method of utilizing a tooth arrangement decal to expedite the preparation of denture set-up as set forth in claim 7, further comprising of fully seating the bite rim in a patient's mouth to confirm desired arrangement and positioning for final denture set-up.

17. A method of utilizing a tooth arrangement decal in the preparation of denture set-up, comprising:
providing at least one tooth arrangement decal comprising:
a first substrate comprising a first surface opposite a second surface,
a removable decorative layer comprising a third surface opposite a fourth surface,
the removable decorative layer being disposed on a first surface of the first substrate,
such that the first surface and the third surface abut;
a layer of removable adhesive disposed on the third surface; and
a decorative image disposed on a fourth surface of the decorative layer;
removing the removable decorative layer and removable adhesive from the first substrate; and
attaching the removable decorative layer and removable adhesive to a wax rim.

18. The method of utilizing a tooth arrangement decal in the preparation of denture set-up as set forth in claim 17, wherein the decorative image comprises a front facing display of at least one of a canine, a lateral incisor, or a central incisor.

19. The method of utilizing a tooth arrangement decal in the preparation of denture set-up as set forth in claim 17, wherein providing at least one tooth arrangement decal comprises selecting the least one tooth arrangement decal for the patient including considerations with respect to midline, low lip line, high lip line, the width of teeth from canine to canine, the horizontal levelness of the teeth, and facial aspect.

20. The method of utilizing a tooth arrangement decal in the preparation of denture set-up as set forth in claim 17, wherein prior to removing the removable decorative layer and removable adhesive from the first substrate, modifying the decal to include a portion of the decal necessary to convey the location and arrangement of the teeth of the denture set-up.
